(19) United States
(12) Patent Application Publication
(10) Pub. No.: US 2003/0048260 A1
(43) Pub. Date: Mar. 13, 2003

(54) System and method for selecting actions based on the identification of user's fingers

(76) Inventor: Alec Matusis, Stanford, CA (US)

Correspondence Address: LUMEN INTELLECTUAL PROPERTY SERVICES, 45 CABOT AVENUE, SUITE 110, SANTA CLARA, CA, 95051, US

(21) Appl. No.: 10/222,195

(22) Filed: Aug. 16, 2002

Related U.S. Application Data
(60) Provisional application No. 60/313,083, filed on Aug. 17, 2001.

(51) Int. Cl. G09G 5/00

(52) U.S. Cl. 345/173

(57) ABSTRACT

Provided is a system and method that increases the functionality of input devices and control panels. A dependent relationship between n functions and n fingertips is associated with an input sensor. Including different motions for each fingertip could extend this dependent relationship and further increase functionality. A user selects only one of his/her fingertips, which then activates the input sensor (through on/off activation and/or motion). The selected fingertip is the only fingertip that is required to activate the input sensor, thereby allowing the input sensor to be arbitrary small. An imaging means is included to identify which fingertip activates the input sensor. Imaging means requires the acquisition of at least one image of a part of the user's hand large enough to identify the selected fingertip activating the input sensor. A processing means is included to determine from data of the input sensor and acquired images which function is selected.

### CROSS-REFERENCE TO RELATED APPLICATIONS

This application is cross-referenced to and claims priority from U.S Provisional application No. 60/313,083 filed Aug. 17, 2001, which is hereby incorporated by reference.

### FIELD OF THE INVENTION

This invention relates generally to input devices. More particularly, the present invention relates to systems for selecting actions or communicating intents based on the identification of user's fingers through imaging.

### BACKGROUND

Input devices that allow a user to select an action are well known in the art and can take different forms. Examples of input devices are, for instance, a keyboard, a mouse, a touch sensor pad or panel, a switch, a button, or the like. A user pressing a key on the keyboard, clicking a clicker on a mouse, touching a sensor pad, flipping a switch or pushing a button, could for instance establish activation of the input device and trigger an action. The various kinds of input devices are used for different types of applications such as entering data in a computer-related system, operating a remote control, handling a personal data assistant, operating an audio-visual device, operating an instrument panel, which are merely examples of the different types of applications where input devices or sensors are used.

One of the main problems in the art of input devices or sensors is the issue of increasing functionality and improving user-friendliness while minimizing the size of the input device. In general, the current input devices could be distinguished into two categories. The first category relates to input devices whereby the action is independent from what actually caused the activation of the input device. The second category relates to input devices whereby the action is dependent from what actually caused the activation of the input device.

An example of the first category of input devices could be illustrated through the use of a keyboard. If a user wants to select the letter “d” on a keyboard, then the user could activate the letter “d” with any finger of his/her left or right hand, or with any other object or device that can isolate the “d” key from the other keys and activate or press the “d” key. In other words, it does not matter what actually activates the “d” key. Therefore the action of any key on a keyboard is categorized as being independent from what actually caused the action of that particular key. Furthermore, each key on a keyboard is related to one action or function. As a person of average skill in the art would readily appreciate, this example merely illustrates the concept of the first category of input devices and this concept also applies to other input devices, such as a virtual keyboard, a mouse, switch, button, touchpad, touchscreen or the like.

Korth in U.S. Pat. No. 5,767,842 teaches the use of a virtual keyboard instead of a physical keyboard. In Korth, the movements of a user's fingers are interpreted as operations on a non-existent virtual keyboard. An image data acquisition system is used for monitoring positions of the user's fingers with respect to the virtual keys on the virtual keyboard. The monitored positions of the fingers of the user's hand operating the virtual keyboard are then correlated to the corresponding key locations on the virtual keyboard. In case of a virtual keyboard, the “d” key is only existent in the virtual sense as a virtual “d” key. Therefore, also for Korth's virtual keyboard, it does not matter what actually activates the virtual “d” key and the action of a key on a virtual keyboard is also categorized as being independent from what caused the action of that particular virtual key.

One way of increasing the functionality of a key on any type of keyboard is to use an alternative key in combination with the “d” key. For instance, one could use the “shift” key in addition to the “d” key to produce capital letter “D”. For a keyboard or similar input device to increase the number of actions or functions, the number of combinations of keys needs to increase or the size of a keyboard needs to increase which both would result in an input device that is impractical. On the other hand it would be possible to decrease the size of the keypads, however, this would also be impractical since the user's fingers might be getting too big in order to discriminate one particular key. However, in all such solutions, the action of a key, whether there are a lot of combinations, a lot of keys or there are a lot of keys in a small space, would still be categorized as being independent from what caused the action of that particular key.

Another method to increase the functionality of an input device is taught in cell phones. Cell phones teach one solution to maximize the number actions using a key that is capable of generating different actions. A single key on a cell phone would normally be associated with four different actions. For instance, such a key could have one number, such as “3” and three different letters, such as “D”, “E”, and “F”. The activation of “D” is based on one touch on the key, “E” is based on two touches on the key, “F” is based on three touches on the key and “3” is based on four touches on the key. However, as a person of average skill would readily acknowledge, such input devices are user-unfriendly since it requires a lot of effort to generate a word like for instance “Cell Phone”.

Bisset et al. in U.S. Pat. No. 5,825,352 teaches the use of multiple fingers for emulating mouse button and mouse operations on a touch sensor pad. The sensor pad senses the proximity of multiple simultaneous fingers or other appropriate objects to the touch sensors. Bisset et al. teaches that their invention can be described in most of its applications by establishing one finger as controlling movement of the cursor, and the second finger as controlling functions equivalent to a mouse button or switch. In this context according to Bisset et al., one finger may be considered the point finger, while the other finger is the click finger.

Although, the method taught by Bisset et al. teaches the possibility of using one sensor pad to generate multiple actions using a combination of fingers or objects, there is absolutely no correlation between the combination of fingers or objects and the following action. For instance, the two fingers in Bisset et al. could be an index finger and thumb. However, the two fingers could also be an index finger and middle finger. For the method of Bisset et al. it does not matter which combination of fingers or even objects is used. Therefore, the action that results from a combination of fingers or objects on a sensor pad as taught in Bisset et al. is also categorized as being independent from what actually caused the action. Furthermore, the method by Bisset et al. might work well for a sensing pad on a standard size notebook, it would be difficult to use the method taught by Bisset et al. for small input device, e.g. where the sensor or input device is smaller than the size of two fingers or tips of fingers. Consequently, the functionality would decrease significantly.

An example of the second category of input devices, whereby the action is dependent from what actually caused the activation of the input device, is taught through the use of a large touchscreen in U.S. Pat. No. 6,067,079 to Shieh who teaches a virtual pointing device for touchscreens. Shieh teaches that in response to the user placing his/her hand on a touchscreen, the touchscreeen detects the sound pattern of the user's palm site of the hand.

The areas of the touchscreen under user's hand then becomes activated such that certain predefined movements of the user's fingers, thumb and/or palm on those activated areas cause certain functions to be invoked. Shieh further teaches that a single click on, for instance, a fingerprint area invokes a single function, such as the “open” function.

In Shieh, the action is correlated with a part of the hand. However, placement of the hand can be anywhere and in any orientation on the touchscreen as long as touchscreen is able to detect the sound pattern of the palm site of the hand. The placement of the hand on the touchscreen is irrelevant as long as a sound image of the palm site of the hand can be obtained and the relative position e.g. a thumb can be distinguished using the sounds handprint to produce the single action predefined for the thumb. In other words, the absolute position of the thumb with respect to the sensor or input device is irrelevant to the selection process of an action, since the relative position of the thumb to hand is what matters.

Furthermore, Shieh's method relies heavily on a large touch screen to obtain the sound hand image. It would therefore be difficult to apply Shieh's method in an application with a touchscreen that is smaller than the size of a hand whereby it would be impossible to obtain the sound handprint. If Shieh's method would be applied on a smaller touchscreen, the functionality of Shieh's method would decrease significantly, since for example to differentiate between three fingers, all three fingers would have to be contacting the touchscreen at the same time.

Accordingly, with the increasing demand of smaller input devices and enhancement of functionality, there is still a strong need to develop new systems and methods that would be able to maximize the number of actions while minimizing the size of the input device. Additionally, in many cases there is a need for a user to select one out of several actions or functions with his/her hands when it is impossible or unsafe to look at the input device. This situation arises when a user controls a car, a plane, or some other machinery, and therefore (s)he has to look in a specific direction, which may prevent the user from looking at the controls. A similar need arises when the user's field of view is limited, for example while looking through a viewfinder, or when the input device is not visible at all, e.g. in the dark. In all these situations there is a need to select one out several functions with user's hands based on tactile feedback only, without looking at the controls.

### SUMMARY OF THE INVENTION

The present invention provides a system and method that increases the functionality of input devices and control panels. The system and method include a dependent relationship between n functions and n fingertips. The system and method further include an input sensor, which is associated with the n functions. A user selects only one of his/her fingertips. The selected fingertip then touches and activates the input sensor. The selected fingertip is the only fingertip that is required to touch and activate the input sensor, thereby allowing the input sensor to be arbitrary small. Up to 8 different functions can be defined for a single input sensor in which each function is correlated and dependent on a fingertip of left or right hand. If multiple input sensors were used in a system, the functionality of that system would then increase significantly. Furthermore, the total number of functions for one input sensor could be further increased to 10 when all the fingertips and thumbs are defined in the dependent relationship between functions and fingertips (and thumbs).

It would even be possible to further increase the number of possible functions for a single input sensor. This could be established by having an input sensor that is not only capable of detecting on/off activation as a result of a fingertip touching or activating the input sensor, but also capable of detecting a motion that is performed by the user at the same time when the user activated the input sensor. In general, m₁, . . . , mₙ motions could be defined respectively corresponding to n fingertips whereby the total number of selectable functions for that single input sensor increases to

$${\sum }_{i = 1}^{n} {m}_{i}$$

(whereby m₁ are integers; note that n fingertips is also corresponding to n functions).

Once the user selects a fingertip, he/she is aware of the selected function, however, the system or device on which the user wants to select the function is not. In order for the system and method of the present invention to determine and identify which fingertip touches and activates the input sensor an imaging means is included. The imaging means requires the acquisition of at least one image (or images) of a part of the user's hand large enough to identify the selected fingertip that activates the input sensor. After the image is obtained, the image is processed by a processing means to determine which fingertip touched and activated the input sensor. The present invention could further include a feedback means (e.g. through executing the selected function, providing sound, providing a display or the like) to provide the user feedback over the selected function.

In view of that which is stated above, it is the objective of the present invention to provide a system and method to select a function from n functions on an input sensor, whereby the input sensor is associated with the n functions and whereby the n functions corresponds to n fingertips.

It is another objective of the present invention to provide an input sensor that is capable of detecting m₁, . . . , mₙ motions respectively corresponding to n fingertips whereby the total number of selectable functions for the input sensor increases to

$${\sum }_{i = 1}^{n} {m}_{i} .$$

It is yet another objective of the present invention to select a function by selecting only one fingertip at a time and only the selected fingertip touches and activates the input sensor.

It is still another objective of the present invention to provide input sensors that are arbitrary small or input sensors that are substantially as small as the selected fingertip.

It is still another objective of the present invention to provide input sensors that are substantially larger than the selected fingertip, which touches and activates the input sensor.

It is still another objective of the present invention to provide input sensors with tactile stimuli.

It is still another objective of the present invention to provide a system and method in which it would be possible to successfully select a function in case the user is prevented from looking at the input sensor or the selected fingertip while the user selects and activates the input sensor.

It is still another objective of the present invention to provide an imaging means to image a part of said user's hand large enough to identify the selected fingertip that activates the input sensor.

It is still another objective of the present invention to provide a processing means to determine the selected function from the identified fingertip by the imaging means and the dependent relationship between the n functions and the n fingertips.

It is still another objective of the present invention to provide a processing means to determine the selected function from the identified fingertip by the imaging means and the dependent relationship between the n fingertips and m₁, . . . , mₙ motions corresponding to the n fingertips.

The advantage of the present invention over the prior art is that the present invention enables one to increase the functionality of systems without necessarily increasing the number of input devices or input sensors. Another advantage of the present invention is that it allows a manufacturer to develop systems that maximizes the number of possible functions or actions of the system while minimizing the size of the system. Still another advantage of the present invention is that it would allow a user to use tactile information from touching the sensor with the selected fingertip, to select a function from a plurality of functions without looking at the controls.

### BRIEF DESCRIPTION OF THE FIGURES

The objectives and advantages of the present invention will be understood by reading the following detailed description in conjunction with the drawings, in which:

FIG. 1 shows an example of a dependent relationship between fingertips and functions according to the present invention;

FIG. 2 shows an example of the method steps for selecting a function based on the selection of the corresponding fingertip according to the present invention;

FIG. 3 shows an example of a dependent relationship between fingertips, motions and functions according to the present invention;

FIG. 4 shows an example of the method steps for selecting a function based on the selection of the corresponding fingertip and motion according to the present invention;

FIGS. 5-10 show examples of different types of possible input sensors according to the present invention. FIGS. 5-10 also show exemplary selections of a fingertip to touch and activate the input sensors according to the present invention;

FIG. 11 shows an example of the system according to the present invention;

FIG. 12 shows an example of an image acquired through the imaging means according to the present invention; and

FIGS. 13-14 show examples of how the system and method of the present invention could be applied.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

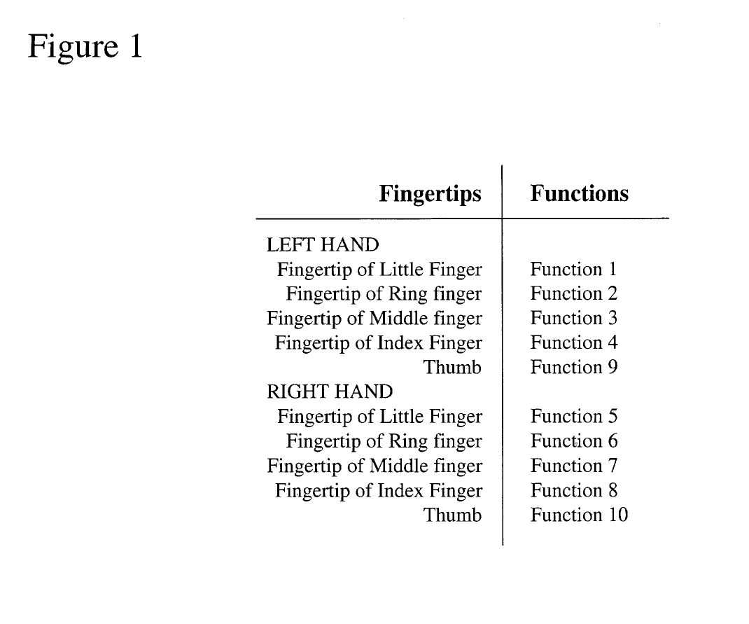

The present invention provides a system and method 100 for selecting a function from a plurality of functions with his/her fingertip. In general, there could be n functions whereby each of the n functions corresponds with n fingertips. For the purpose of the present invention, function has the same meaning as action or intent. As it is shown in FIG. 1, there is a dependent relationship between each fingertip and the corresponding function. The least number of dependent relationships is 2, i.e. when n is 2. The example shown in FIG. 1 shows the fingertips of the left and right hand. Including all the fingertips it would be possible to define a maximum of 8 different functions, i.e. when n is 8. The determination of which fingertip should correspond to which function is completely arbitrary and simply a matter of choice or preference. The correspondence, i.e. the dependent relationship, between fingertip and function is usually preset in a system by the manufacturer. However, it is also possible for the manufacturer to allow the user of the system to define this corresponding relationship, as he/she prefers. Furthermore, the total number of functions could be increased to 10 if one also includes the thumb of the left and right hand as shown in FIG. 1.

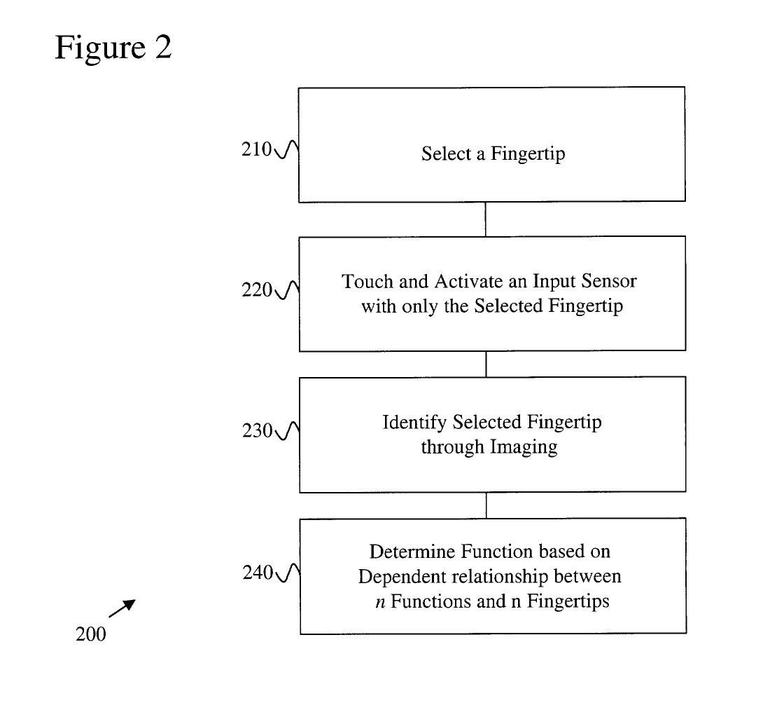

As it is shown in FIG. 2, the key idea of the system and method 200 of the present invention is that a user selects 210 only one fingertip at a time. The user is aware of the particular function that corresponds to the selected fingertip. With the selected fingertip, i.e. only the selected fingertip, the user touches and activates 220 an input sensor. It is important to realize that the user is not using his/her other fingertips when touching the input sensor. This offers great advantages to systems and methods in which it would now be possible to maximize the number of functions while minimizing the size of the input sensor. With a single input sensor, a manufacturer of the device or system has the opportunity to define up to 10 different functions, i.e. when n is 10, which correspond to different fingertips for a single input sensor. This would not only increase the functionality of the system, it would also make the selection process easier as well as it would decrease potential injuries such as repetitive strain injuries associated with repetitive typing or pressing.

Once the user selects a fingertip, he/she is aware of the selected function, however, the system or device on which the user wants to select the function is not. Imaging 230 is used in order for the system and method of the present invention to determine and identify which fingertip touches and activates the input sensor. Imaging 230 requires at least one image of a part of the user's hand large enough to identify the selected fingertip that activates the input sensor. After the image is obtained, the image is processed 240 to determine which fingertip touched and activated the input sensor (more details about imaging and processing are provided infra). Processing includes that the identified fingertip based on imaging is compared in a look-up table. The look-up table contains the dependent relationship between the fingertips and functions in order to determine the corresponding function for the identified fingertip.

Understanding the concept of the present invention described so far, it would be possible to further increase the number of possible functions for a single input sensor. This is established by having an input sensor that is not only capable of detecting on/off activation, but also capable of detecting a motion that is performed by the user at the same time when the user activated the input sensor. For only one fingertip one could then define p motions for a single input sensor (whereby p is an integer). In general, m₁, . . . , mₙ motions could be defined respectively corresponding to n fingertips whereby the total number of selectable functions for that single input sensor increases to

$${\sum }_{i = 1}^{n} {m}_{i}$$

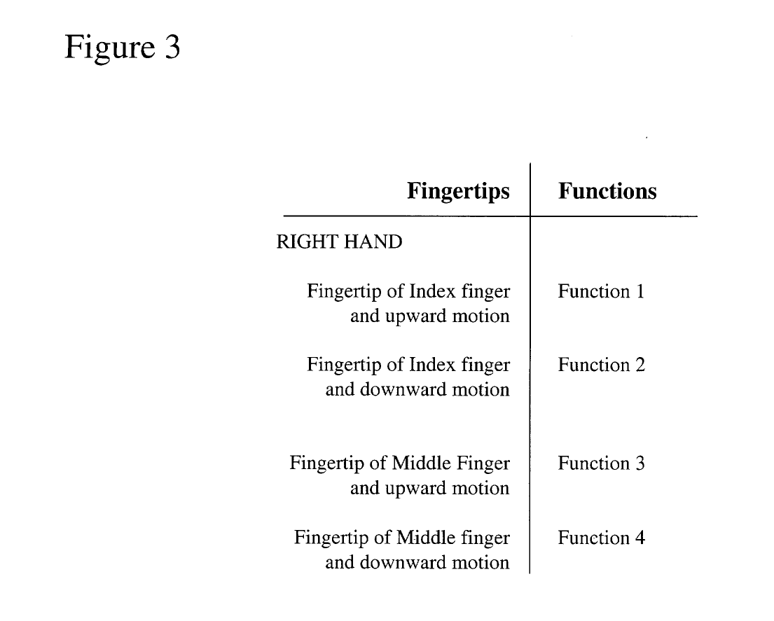

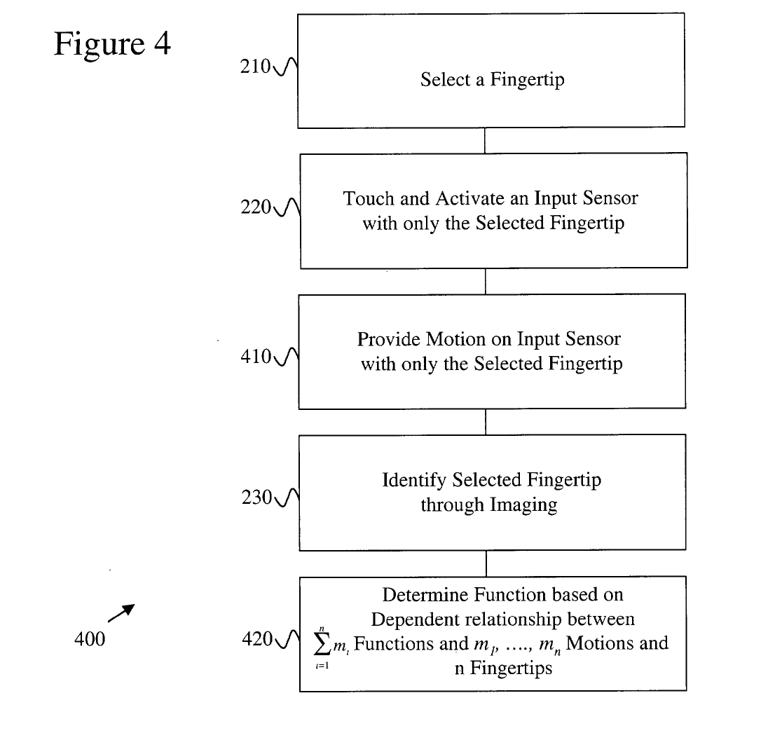

(whereby m₁ are integers; note that n fingertips is also corresponding to n functions as discussed supra with respect to FIGS. 1-2). FIG. 3 shows an example of two different fingertips for the right hand whereby each fingertip corresponds to an upward motion and a downward motion. By having two fingertips (i.e. when n is 2) and two different motions for each fingertip (i.e. when m₁ is 2 and m₂ is 2) the total number of different functions is then 4, i.e. m₁+m₂=4. FIG. 4 shows a system and method 400 that is similar to system and method 200 as it is discussed supra and with respect to FIG. 2. The difference between FIG. 2 and FIG. 4 is the addition of providing motion 410 by the selected fingertip. Since a function is now dependent on the selected fingertip and the provided motion by the selected fingertip, processing 420 now further includes determining the function that corresponds to the identified fingertip based on imaging 230. A look-up table that contains the dependent relationship between the fingertips, motions and functions is used to determine the functions given the identified fingertip.

The input sensor could be an arbitrary small input sensor. The input sensor could also be substantially as small as or smaller than the selected fingertip. Input sensor could include any kind of electrical elements or heat-conducting elements to either sense binary on/off activation and/or resistive membrane position elements or position sensor elements to sense motion. Input sensors could therefore take different forms such as, for instance, but not limited to, a keypad, button, a contact point, a switch, a touchscreen, a trackpad, or a heat-conducting pad. Although for some applications it would be preferred and advantageous to utilize a small input sensor, such as a small keypad, the present invention is not limited to the use of a small input sensor. The concept of the present invention would also work for large input sensors. It would for instance be easier for a user to locate a large input sensor, large input sensors would be advantageous for the applications when the user has to select one out of a plurality of functions without looking at the input sensor, based on the tactile feedback only. These large input sensors (e.g. substantially larger than the area of a fingertip) would be equipped with a coordinate location mechanism (such as in laptop trackpads) for identifying the coordinate of the contact point of the selected fingertip with the input sensor, which would then be used by the image recognition algorithm.

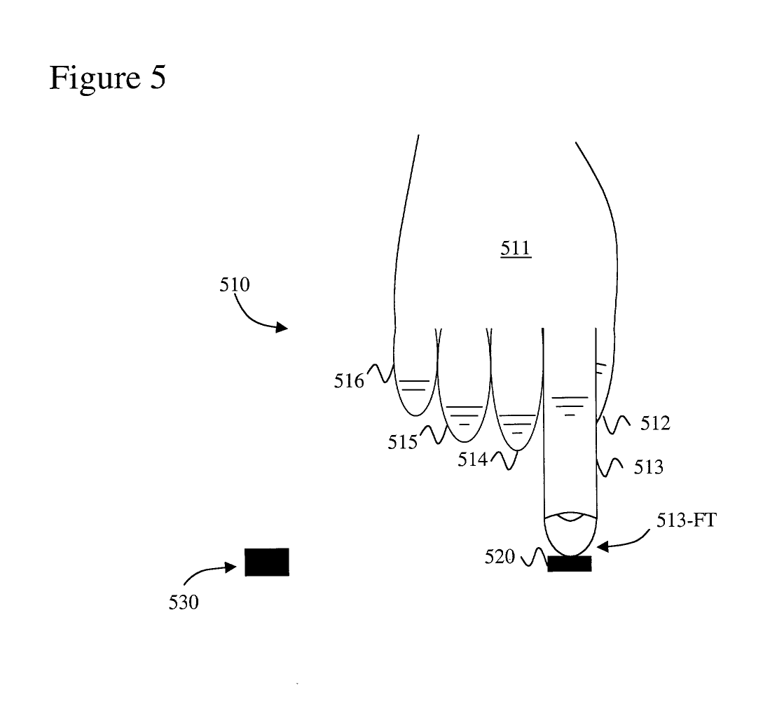

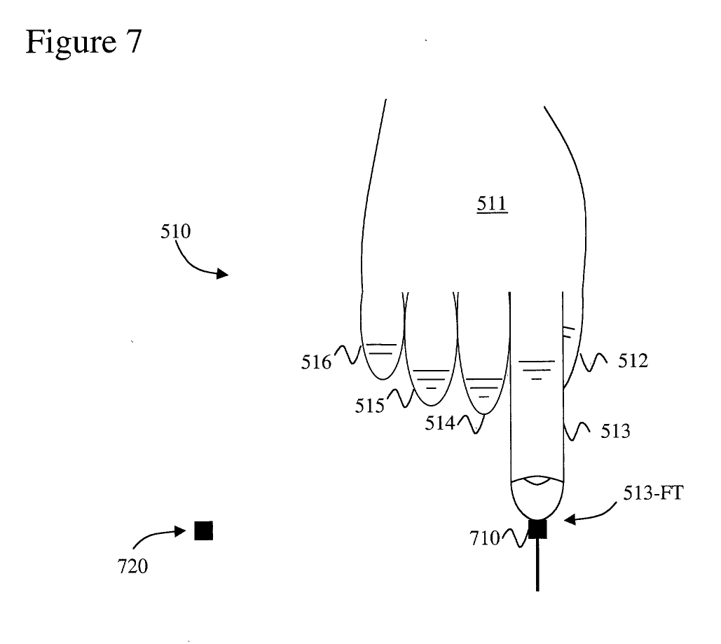

FIGS. 5-10 show different examples of input sensors or devices. FIG. 5 shows the dorsal site of a user's right hand 510. User's right hand 510 shows the dorsal part 511 of the hand which is opposite from the palm of the hand, thumb 512, index finger 513, middle finger 514, ring finger 515, and little finger 516. Thumb 512, index finger 513, ring finger 515, and little finger 516 are shown in a flexed position (i.e. bringing the fingertips in a direction toward the palm site of the hand), whereas index finger 513 is in an extended position, substantially extended position or partially flexed position. It would only be necessary for the non-selected fingers to not obscure the view of the selected finger by the imaging device; thus the non-selected fingers can also be in substantially extended or partially flexed position. In the example of FIG. 5, the user has selected fingertip 513-FT of index finger 513 to touch and activate input sensor 520. Input sensor 520 could be a keypad, a switch or a button. It should be noted that the size of input sensor 520 (530 shows a top view of input sensor 520) in this example is substantially as small as fingertip 513-FT.

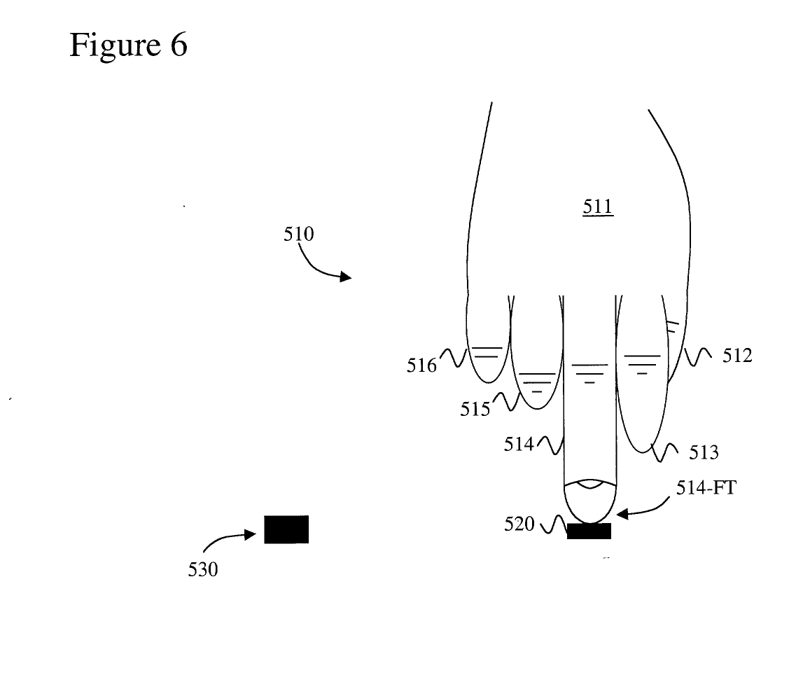

FIG. 6 shows a similar example as in FIG. 5 with the difference that the user has selected fingertip 514-FT of middle finger 514 to touch and activate input sensor 520. In the example of FIG. 6, the user has selected fingertip 514-FT of middle finger 514 to touch and activate input sensor 710. Input sensor 710 could be an arbitrary small input device or sensor. It should be noted that the size of input sensor 710 (720 shows a top view of input sensor 710) in this example is substantially smaller than fingertip 514-FT.

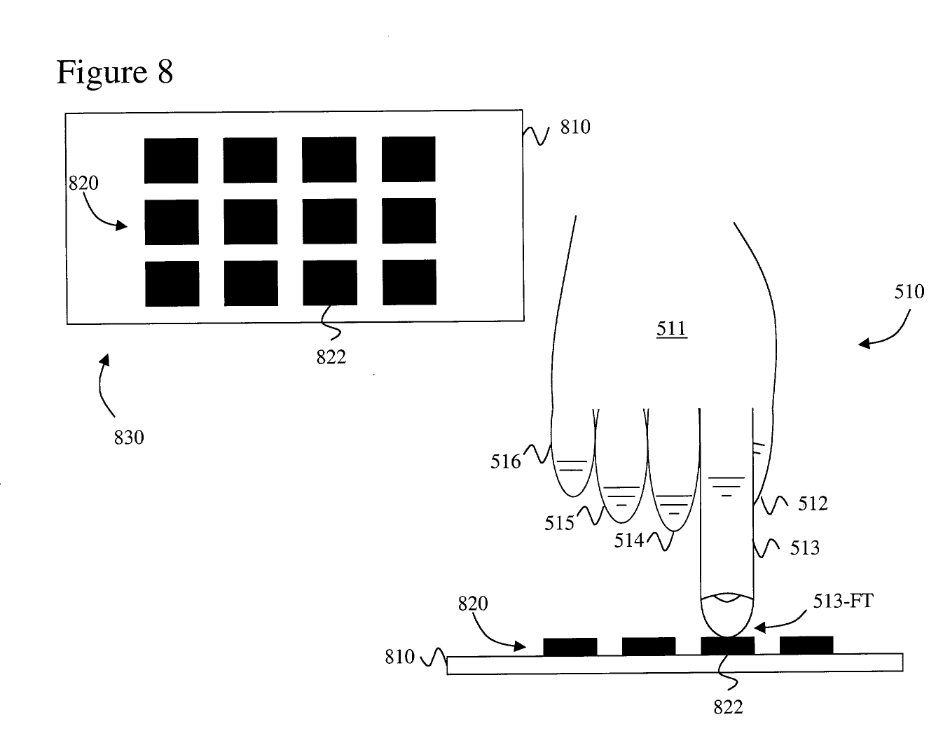

FIG. 8 shows an example of multiple input sensors 820 that are distributed on top of a support surface 810. In the example of FIG. 8, the user has selected (1) fingertip 513-FT of index finger 513 and (2) input sensor 822 out of all 12 input sensors 820 to touch and activate input sensor 822. In this example, input sensors 820 are shown are keypads or buttons. It should be noted that the size of input sensors 820 (830 shows a top view of input sensors 820) in this example are each substantially as small as fingertip 513-FT.

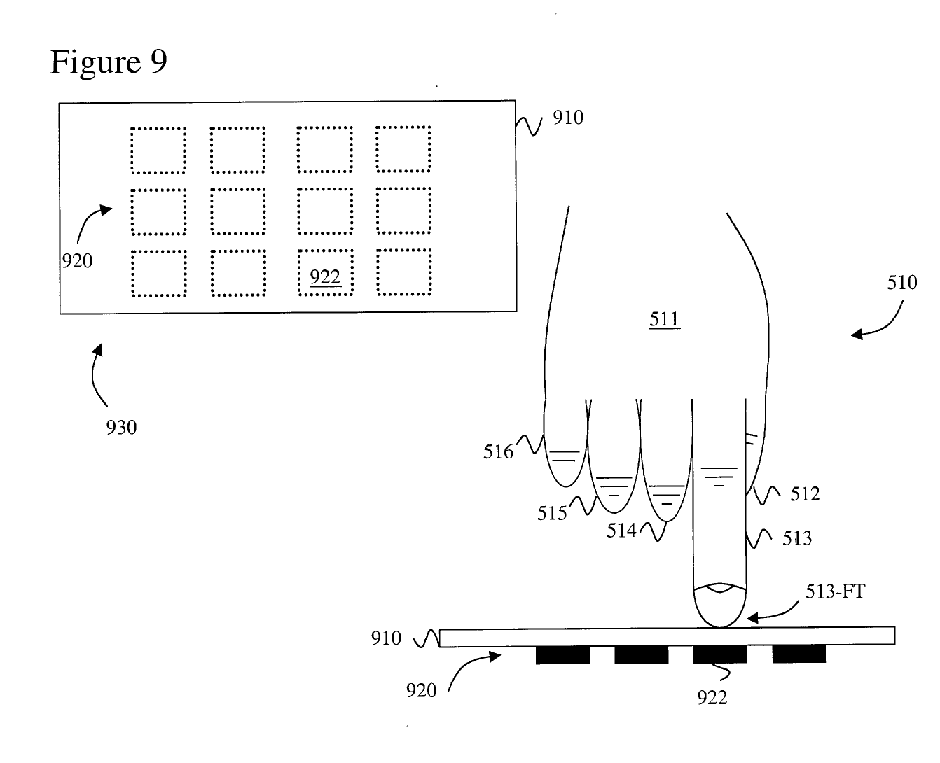

FIG. 9 shows input sensors 920 distributed in a similar fashion as in FIG. 8 with the difference that input sensors 920 are now underneath a surface 910. An example of support surface 910 is a touchscreen, whereby input sensors 920 are distributed underneath the touchscreen. In the example of FIG. 9, the user has selected (1) fingertip 513-FT of index finger 513 and (2) input sensor 922 out of all 12 input sensors 920 to touch and activate input sensor 922. Surface 910 could be transparent so that the user has the opportunity to recognize the location of each of the input sensors 920, or surface 910 could has markings or illustrations to help visualize and/or localize where the user should touch surface 910 in order to select the intended input sensor. It should be noted that the size of input sensors 920 (930 shows a top view of input sensors 920) in this example are each substantially as small as fingertip 513-FT.

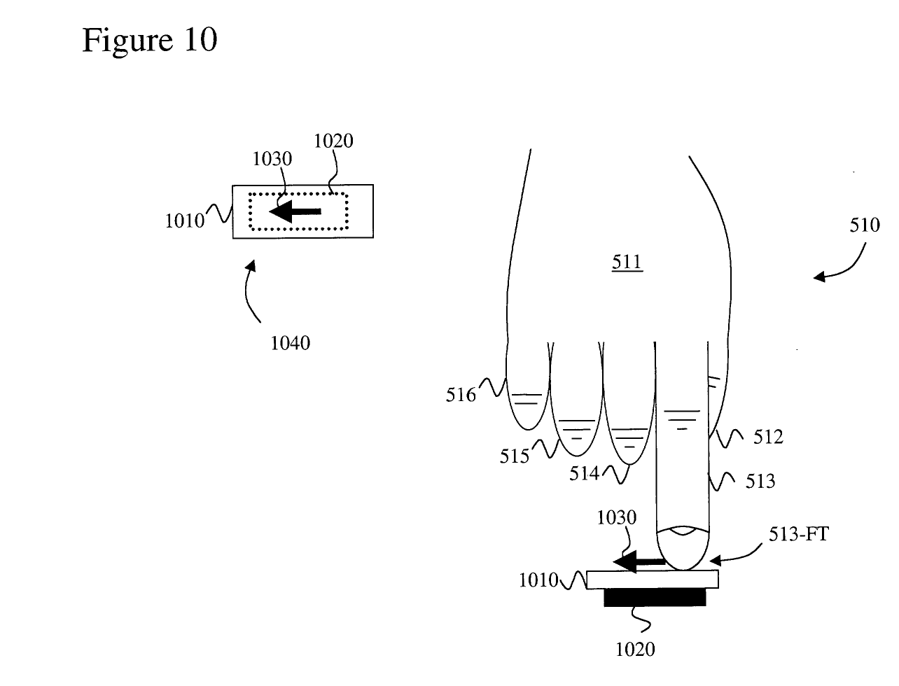

FIGS. 5-9 show examples in which the user could activate the input sensor with a fingertip either by pressing the input sensor, touching the input sensor, flipping the input sensor, bending the input sensor, or the like. The present invention is not limited to the means by which the user activates an input sensor and as a person of average skill in the art to which this invention pertain would understand, the type of activation by a user is also dependent on the type of input sensor. FIG. 10 shows an example whereby the activation is expanded by including motion performed through the selected fingertip on the input sensor (or a stroke by the fingertip on the input sensor). FIG. 10 shows surface 1010 with an input sensor 1020. An example of such an input sensor 1020 is, for instance, a resistive membrane position element as is common in the art as input device or sensor on notebook computers, personal digital assistants or personal pocket computers. FIG. 10 shows an exemplary motion or stroke 1030 by fingertip 513-FT on surface 1010 that would be recognized or sensed by input sensor 1020. It should be noted that the size of input sensor 1020 (1040 shows a top view of input sensor 1020) in this example could be substantially as small as fingertip 513-FT. However, as a person of average skill in the art to which this invention pertain would readily recognize, the size of input sensor 1020 and thereby the size of the motion or stroke 1030 is depended on the sensitivity of input sensor 1020 and the ability of the input sensor 1020 to distinguish the different motions that one wants to include and correlate to different functions.

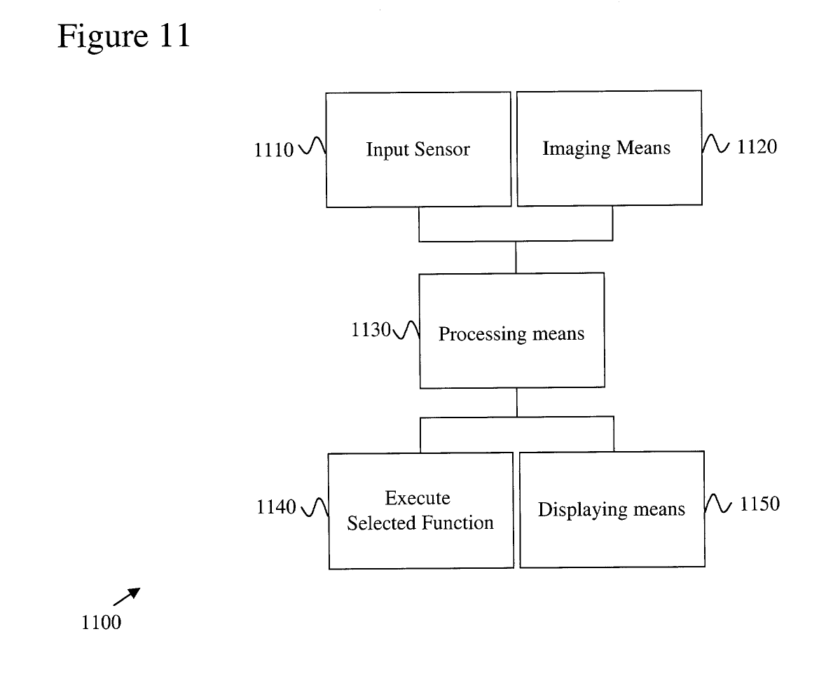

FIG. 11 shows an example of a system 1100 according to the present invention. System 1100 includes at least one input sensor 1110. In order to identify the selected fingertip that activates input sensor 1110, system 1100 further includes an imaging means 1120. Imaging means 1120 images a part of the user's hand large enough to identify the selected fingertip touching and activating input sensor 1110. In case only one hand is defined in the corresponding relationship between fingertips and functions, then imaging means 1120 only need to be able to identify from the image the different fingertips from that hand in order to correctly identify to selected fingertip. In case both the left and right hand are defined in the corresponding relationship between fingertips and functions, then imaging means 1120 needs to be able to identify the different fingertips from the right and left hand in order to correctly identify to selected fingertip. Imaging means 1120 preferably images the dorsal site of the hand as shown in FIGS. 5-10. However, imaging means 1120 is not limited to only the dorsal site of the hand since it would also be possible to image the palm site of the hand.

Imaging means 1120 is preferably a miniature imaging means and could be a visible sensor, an infrared sensor, an ultraviolet sensor, an ultrasound sensor or any other imaging sensor capable of detecting part of the user's hand and identifying the selected fingertip. Examples of imaging means 1120 that are suitable are, for instance, but not limited to, CCD or CMOS image sensors.

Imaging means 1120 is located in a position relative to input sensor(s) 1110. Imaging means 1120 could be in a fixed position relative to input sensor(s) 1110 or imaging means 1120 could be in a non-fixed or movable position relative to input sensor(s) 1110, but in both cases the position of the input sensor(s) 1110 in the image frame has to be known to the image processing algorithm in advance, before processing the image frame. It would be preferred to have an imaging means 1120 that includes an auto-focus means for automatically focusing the part of user's hand and making sure that optimal quality images are acquired for the identification process. Furthermore, imaging means 1120 could also include automatic features to control and adjust the brightness, color or gray scaling of the image. Imaging means 1120 could also include optical elements, such as lenses or mirrors, to optimize the field of view or quality of the image. For instance, dependent on the location and distance between input sensor 1110 and imaging means 1120, imaging means 1120 could include lenses to ensure that imaging means 1120 enables a proper field of view to identify based on the acquired image the selected fingertip.

So far, imaging means 1120 is discussed in relation to the acquisition of one image. However, this would be just one possibility of imaging the selected fingertip using imaging means 1120. In case of one image, the image is preferably taken at the time input sensor 1110 is activated. In other words, the activation of input sensor 1110 triggers imaging means 1120 at which time the image is taken. Another possibility is that imaging means 1120 acquires a continuous stream of image frames, at a frame rate of, for instance, but not limited to, 30 fps. In case a continuous stream of image frames is acquired, imaging means 1120 is no longer triggered by input sensor 1110 and therefore the time of activation or time of contact of the selected fingertip is important to be obtained from the input sensor 1110 along with the continuous stream of image frames from imaging means 1120 in order to synchronize the images with the time of activation or time of contact.

In order to identify the selected fingertip and therewith the selected function, system 1100 further includes a processing means 1130 to process the inputs from input sensor 1110 and imaging means 1120. The objective of processing means 1130 is to identify the selected function based on those inputs. Processing means 1130 preferably includes software algorithms that are capable of processing the different inputs and capable of capturing and processing the images. Processing means 1130 also includes the appropriate analog to digital conversion devices and protocols to convert analog signals to digital signals to make the inputs ready for digital processing. The input from input sensor 1110 to processing means 1130 provides information over:

(1) The fact that input sensor 1110 is activated or in case of multiple input sensors which input sensor 1110 out of the multiple input sensors is activated;

(2) The timing of the activation of input sensor 1110;

(3) The electrical (e.g. resistive) changes as a function of time during the motion of the selected finger over input sensor 1110 in case motion is defined with respect to a function; and/or

(4) The coordinate of the contact point of the selected fingertip with input sensor 1110, supplied by input sensor 1110 in case when input sensor 1110 is substantially larger than the fingertip.

The input from imaging means 1120 to processing means 1130 includes:

(1) An image of a part of the user's hand large enough to identify from the image the selected fingertip taken at the time of activation; or

(2) A continuous stream of image frames of a part of the user's hand whereby each image is large enough to identify from the image the selected fingertip. In this case imaging means 1120 also provides to processing means 1130 a timeline that can be synchronized with the timestamp obtained from input sensor 1110.

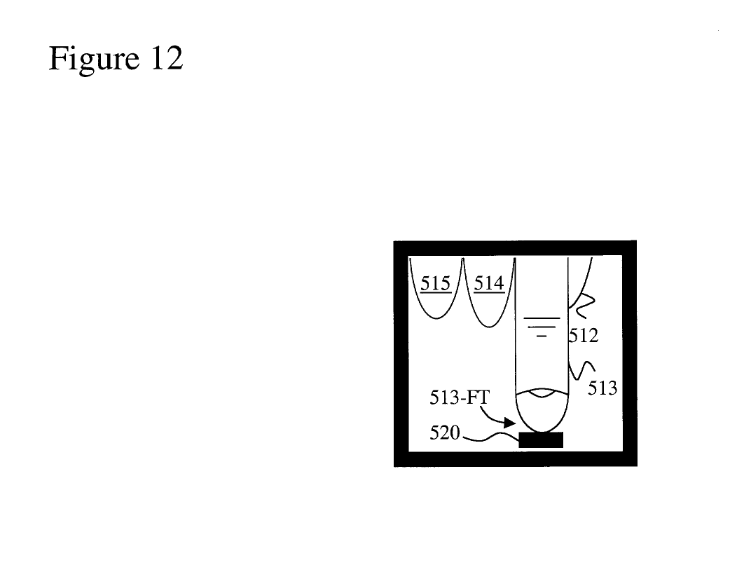

In order to identify the selected fingertip from an image, processing means 1130 includes pattern recognition software algorithm to recognize the shape of part of the hand that was imaged. Based on this shape and its relative position to the known location of input sensor 1110 (or the contact point when input sensor 1110 is large) in image 1200, the pattern recognition software algorithm recognizes which fingertip activated input sensor 1110. For instance, as it is shown in FIG. 12, image 1200 contains index finger 513, part of the proximal phalange of thumb 512, part of the proximal phalange of middle finger 514 and part of the proximal phalange of index finger 515. Based on the shape of these different fingers and relative position of these different fingers to the known position of input sensor 520 (or the location of the contact point of selected fingertip 513-FT with input sensor 520, when input sensor 520 is large) in image 1200, pattern recognition software algorithm would be able to recognize that fingertip 513-FT of index finger 513 has activated input sensor 520. As a person of average skill in the art to which this invention pertains would readily appreciate, the amount of information in an image like image 1200 could vary dependent on the abilities of the pattern recognition software algorithm and total number of fingertips that are involved in the particular application (i.e. the fewer fingertips that are defined in correspondence to functions and/or motions, the less information is needed from image 1200 and the smaller image 1200 could be).

From image 1200 pattern recognition software algorithm could for instance recognize the nail on index finger 513 to determine that the dorsal site of the hand is shown in image 1200. Pattern recognition software algorithm could then recognize that four fingers are present based on the overall width of the image of the part of the hand relative to the width of a typical finger (assuming that the distance to the input sensor or a contact point from or imaging means (image sensor) and thus an average thickness of a user's finger on the image is a known). The pattern recognition algorithm could recognize that the user is contacting input sensor 520 with selected finger 513, since the contacting or selected finger is always above the known location of input sensor 520 (or the contact point). Furthermore, pattern recognition software algorithm could recognize one finger on the right site of the selected finger and two fingers on the left site of the extended finger. (interpreted from the perspective shown in image 1200). In addition, pattern recognition software algorithm could recognize that the one finger on the right site of the extended finger is only partially visible indicating that this is the thumb. This information would be enough to identify that the extended finger is the index finger. It would also be possible to have less information in image 1200 in case only the index and middle finger are defined with respect to a function. In this case of only the index and middle finger, an image showing the thumb, index finger and middle finger would be sufficient. As a person of average skill in the art to which this invention pertains would readily appreciate, different kinds of intelligent rules or techniques could be applied to identify the selected fingertip, such as, for instance, but not limited to, supervised learning algorithms such as neural networks or support vector machines, fuzzy rules, probabilistic reasoning, any type of heuristic approaches or rules, or the like.

It would also be possible for processing means 1130 to include a database of stored images that contain different possible finger and fingertip orientations. These images can then be used as a map and comparison for the acquired image. In this case, processing means 1130 also includes software algorithms (which are known in the art) that are able to do contour mapping, least square analyses, or the like to determine whether one of the stored maps fits the shape of the obtained image.

In case motion is defined with respect to a function, the electrical (e.g. resistive) changes as a function of time during the motion of the selected finger over input sensor 1110 need to be interpreted. Therefore, processing means 1130 could also include software algorithms, which are known in the applications for personal digital assistants, to interpret the coordinates, scalar and vector components of the acquired motion. Furthermore, processing means 1130 would include pattern recognition software algorithms to identify the stroke or motion.

Processing means 1130 could also include software algorithms to distinguish the static background field in image 1200 and the moving parts of the hand in image 1200. This would, for instance, be possible by identifying the vertical motion of the selected fingertip toward input sensor 1110 over a series of image frames before or immediately after the time of activation of input sensor 1110.

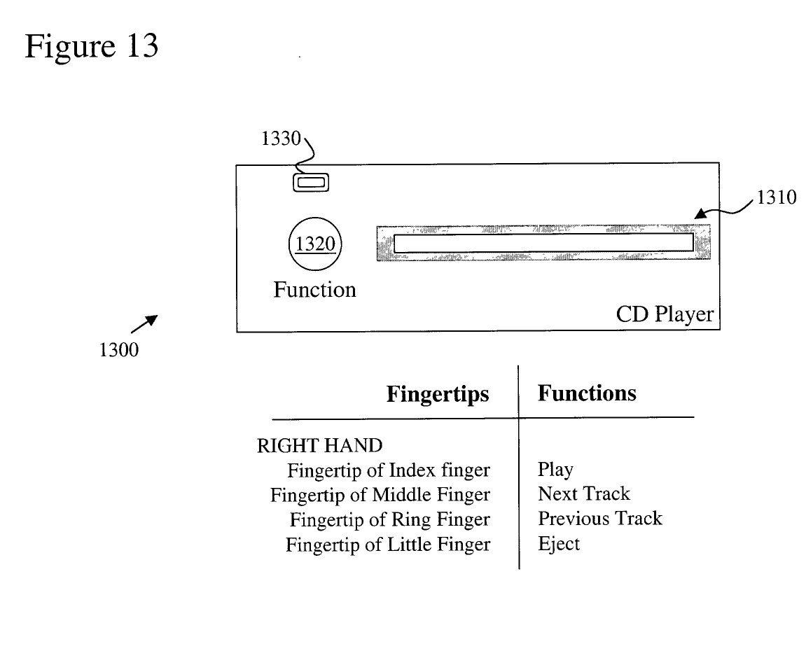

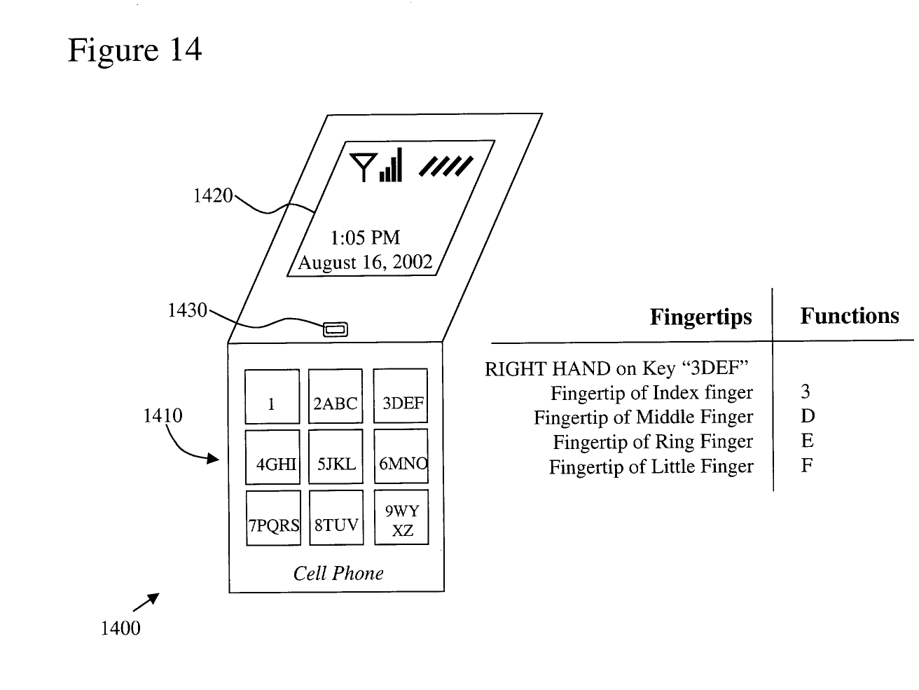

Once processing means has identified the selected function, system 1100 could further include an output means 1140 that is capable of executing the selected function as is discussed infra in relation to two different applications with respect to FIGS. 13-14. The user could also obtain feedback over his/her selected function by including a feedback means 1150 in system 1100. Feedback means 1150 could be any type of feedback architecture such as audio through sounds or voices, visual through any kind of display, or tactile through vibration or any tactile stimuli. Feedback means 1150 could also be provided through the execution of the selected action or function (in this case there won't be a need for an additional feedback means 1150 since it could simply be built-in with the system).

The present invention could be used in a wide variety of applications such as, but not limited to, applications where the user is prevented to look at the input sensor or at the selected fingertip while the user selects and activates the input sensor. This would, for instance, be possible in situation where a user needs to select a function or express his/her intention, but it would simply be unsafe or impossible to look at the input sensor or at the selected fingertip while the user selects and activates the input sensor. These situations could arise when a user controls a car, a plane, or some other machinery, and therefore (s)he has to look in a specific direction, which may prevent the user from looking at the input sensors or controls. A similar need arises when the user's field of view is limited, for example while looking through a viewfinder, or when the input sensor or control is not visible at all, e.g. in the dark. In all these situations there is a need to select one out several functions with user's hands based on tactile information only, without looking at the controls. In order to enhance tactile feedback from touching the input sensor, input sensors of the present invention could include tactile stimuli, such as, for instance, but not limited to, a fuzzy, scratchy, rough or abrasive button. It could also include bumps, lines or shapes in a particular overall shape or orientation, some of this which is common in braille, i.e. a system of writing or printing for the blind in which combinations of tangible dots or points are used to represent letters, characters etc, which are “read” by touch. Needless to say, another possibility where the present invention would be advantageous is for the blind. A blind person would only need to know which fingertip corresponds to which function and thereby the task of selecting a function or expressing intent would be made easier and user-friendly.

Most of the applications where the present invention would be useful deal with instrument or control panels, such as (1) an audiovisual display of a radio, video-player, DVD-player or the like, (2) a instrument panel in a vehicle, an airplane or a helicopter, (3) a remote control device, (4) a wireless communication device such as a cell phone or the like, (5) a computer device such as a notebook, personal digital assistant, pocket PC or the like, (6) bank machines such as ATM machines, (7) industrial controls, (8) vending machine, or (9) videogame console. The present invention would be advantageous in application where there is a need to minimize the size of the system or device while maintaining or increasing the number of possible options or functions. Examples are, for instance, a cell phone, personal digital assistant or pocket PC where the manufacturer would like to increase the functionality while at the same time miniaturize the system or device.

FIGS. 13-14 show respectively two different examples of potential applications related to a CD-player 1300 and a cell phone 1400. CD-player 1300 includes a slot 1310 to insert a CD, one input sensor 1320 in the form of a button, and an imaging means 1330 positioned relative to input sensor 1320 in such a way that imaging means 1330 could acquire image of a part of the user's hand large enough to identify from the image the selected fingertip. One of the possibilities for input sensor 1320 is to define four different functions related to some basic operations of CD-player 1300. For instance, one could define four different functions corresponding and dependent on the fingertips of the right hand, i.e. fingertip of the index fingertip is correlated to the function “play”, fingertip of the middle fingertip is correlated to the function “next track”, fingertip of the ring fingertip is correlated to the function “previous track”, and fingertip of the little fingertip is correlated to the function “eject”. As a person of average skill in the art to which this invention pertains would readily appreciate, additional functions could be defined, as well as additional input sensors each with their own defined functions could be added to improve the functionality and user-friendliness of CD-player 1300.

Cell phone 1400 pretty much looks similar to currently available cell phone such as a section for keypads 1410 and a feedback means 1420 in the form of a display unit. The difference, however, is that cell phone 1400 further includes keypads in which it is no longer necessary to press multiple times to select or activate a function. As discussed in the background section supra for current cell phones, the activation of, for instance, “D” is based on one touch on the key, “E” is based on two touches on the key, “F” is based on three touches on the key and “3” is based on four touches on the key. On the contrary, cell phone 1400 of the present invention would only require keypads that can sense a single touch or activation. Cell phone 1400 of the present invention would now include an imaging means 1430 and a processing means (not shown) as discussed supra. Cell phone 1400 is not limited to a keypad since it could include any type of input sensor, such as a touchscreen, in order to communicate user's intent or selection of function, including motion detection sensors as discussed supra. For instance, the individual keypads of cell phone 1400 could be used as small trackpads to select functions or action on, for instance the display area of cell phone 1400.

Imaging means 1430 is positioned relative to input sensors 1410 in such a way that imaging means 1430 could acquire an image that contains a part of the user's hand large enough to identify from the image the selected fingertip. One of the possibilities for input sensor related to keypad “3DEF” is to define four different functions related to some basic operations of this keypad. For instance, one could correlate four different fingertips of the right hand to the selection of function “3”, “D”, “E”, and “F”. For instance, one could define fingertip of the index fingertip is correlated to the function “3”, fingertip of the middle fingertip is correlated to the function “D”, fingertip of the ring fingertip is correlated to the function “E”, and fingertip of the little fingertip is correlated to the function “F”. As a person of average skill in the art to which this invention pertains would readily appreciate, additional functions could be defined for this keypad, as well as additional input sensors each with their own defined functions could be added to improve the functionality and user-friendliness of cell phone 1400.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed is:

1. A system for selecting by a user a function from n functions, wherein said n is at least 2 and wherein said selection of said function is dependent on the identification of said user's fingertip, comprising:
(a) an input sensor, wherein said input sensor is associated with said n functions, and said n functions correspond to n fingertips of said user; and
(b) said user to select said function by selecting only one of said n fingertips at a given time, and only said selected fingertip touches and activates said input sensor.

2. The system as set forth in claim 1, wherein said input sensor is an arbitrary small input sensor.

3. The system as set forth in claim 1, wherein said input sensor is substantially as small as said selected fingertip.

4. The system as set forth in claim 1, wherein said input sensor is substantially larger than said selected fingertip, and said input sensor is equipped with coordinate location mechanism which identifies the coordinate of the point of contact of said selected fingertip with said input sensor.

5. The system as set forth in claim 1, wherein said input sensor comprises a keypad, button, a contact point, a switch, a touchscreen, a trackpad, or a heat-conducting element.

6. The system as set forth in claim 5, wherein said touchscreen comprises additional input sensors, and said input sensor covers only part of said touchscreen.

7. The system as set forth in claim 1, wherein said input sensor comprises tactile stimuli.

8. The system as set forth in claim 1, wherein said input sensor is capable of detecting m₁, . . . , mₙ motions respectively corresponding to said n fingertips whereby the total number of selectable functions for said input sensor increases to
$${\sum }_{i = 1}^{n} {m}_{i} .$$

9. The system as set forth in claim 1, wherein said user is prevented to look at said input sensor or said selected fingertip while said user selects and activates said input sensor.

10. The system as set forth in claim 1, further comprising an imaging means, wherein said imaging means images a part of said user's hand large enough to identify said selected fingertip that activates said input sensor.

11. The system as set forth in claim 10, wherein said imaging means is a miniature imaging means.

12. The system as set forth in claim 10, wherein said imaging means comprises a visible sensor, an infrared sensor, an ultraviolet sensor, or an ultrasound sensor.

13. The system as set forth in claim 10, wherein said imaging means comprises auto-focus means for automatically focusing said part of user's hand.

14. The system as set forth in claim 10, wherein said part of said user's hand comprises the dorsal site of said user's hand.

15. The system as set forth in claim 10, further comprising a processing means to determine said selected function from said identified fingertip by said imaging means and said correlation of said n functions with said n fingertips of said user.

16. The system as set forth in claim 10, wherein said input sensor is capable of detecting m₁, . . . , mₙ motions respectively corresponding to said n fingertips and further comprising a processing means to determine said selected function from said identified fingertip by said imaging means and said correlation of said n functions with said n fingertips of said user and said m₁, . . . , mₙ motions corresponding to said n fingertips.

17. The system as set forth in claim 10, further comprising a processing means to output said selected function.

18. The system as set forth in claim 1, further comprising a feedback means to provide said user with feedback over said selected function.

19. A method for selecting by a user a function from n functions, wherein said n is at least 2 and wherein said selection of said function is dependent on the identification of said user's fingertip, comprising the steps of:
(a) providing an input sensor, wherein said input sensor is associated with said n functions, and said n functions correspond to n fingertips of said user; p1 (b) selecting by said user said function by selecting only one of said n fingertips at a given time; and
(c) activating said input sensor with only said selected fingertip, wherein only said selected finger touches said input sensor.

20. The method as set forth in claim 19, wherein said input sensor is an arbitrary small input sensor.

21. The method as set forth in claim 19, wherein said input sensor is substantially as small as said selected fingertip.

22. The method as set forth in claim 19, wherein said input sensor is substantially larger than said selected fingertip, and said input sensor is equipped with coordinate location mechanism which identifies the coordinate of the point of contact of said selected fingertip with said input sensor.

23. The method as set forth in claim 19, wherein said input sensor comprises a keypad, button, a contact point, a switch, a touchscreen, a touchpad, or a heat-conducting element.

24. The method as set forth in claim 23, wherein said touchscreen comprises additional input sensors, and said input sensor covers only part of said touchscreen.

25. The method as set forth in claim 19, wherein said input sensor comprises tactile stimuli.

26. The method as set forth in claim 19, wherein said input sensor is capable of detecting m₁, . . . , mₙ motions respectively corresponding to said n fingertips whereby the total number of selectable functions for said input sensor increases to
$${\sum }_{i = 1}^{n} {m}_{i} .$$

27. The method as set forth in claim 19, wherein said user is prevented to look at said input sensor or said selected fingertip while said user selects and activates said input sensor.

28. The method as set forth in claim 19, further comprising the step of providing an imaging means, wherein said imaging means images a part of said user's hand large enough to identify said selected fingertip that activates said input sensor.

29. The method as set forth in claim 28, wherein said imaging means is a miniature imaging means.

30. The method as set forth in claim 28, wherein said imaging means comprises a visible sensor, an infrared sensor, an ultraviolet sensor, or an ultrasound sensor.

31. The method as set forth in claim 28, wherein said imaging means comprises auto-focus means for automatically focusing said part of user's hand.

32. The method as set forth in claim 28, wherein said part of said user's hand comprises the dorsal site of said user's hand.

33. The method as set forth in claim 28, further comprising the step of providing a processing means to determine said selected function from said identified fingertip by said imaging means and said correlation of said n functions with said n fingertips of said user.

34. The method as set forth in claim 28, wherein said input sensor is capable of detecting m₁, . . . , mₙ motions respectively corresponding to said n fingertips and further comprising the step of providing a processing means to determine said selected function from said identified fingertip by said imaging means and said correlation of said n functions with said n fingertips of said user and said m₁, . . . , mₙ motions corresponding to said n fingertips.

35. The method as set forth in claim 19, further comprising the step of providing a processing means to output said selected function.

36. The method as set forth in claim 19, further comprising the step of providing a feedback means to provide said user with feedback over said selected function.

37. A system for selecting by a user a function from n functions using tactile information, comprising:
(a) an input sensor, wherein said input sensor is associated with said n functions, wherein said n functions correspond to n fingertips of said user, and wherein said input sensor comprises tactile stimuli to provide said user with said tactile information related to said input sensor;
(b) said user to select said function by selecting only one of said n fingertips at a given time and only said selected fingertip touches and activates said input sensor, and wherein said user is prevented from looking at said input sensor during user's selection; and
(c) an imaging means, wherein said imaging means images a part of said user's hand large enough to identify said selected fingertip that activates said input sensor.

38. A system for communicating a user's intent, comprising:
(a) an input sensor, wherein said input sensor is associated with said n intents, and said n intents correspond to n fingertips of said user;
(b) said user to select said intent by selecting only one of said n fingertips at a given time, and only said selected fingertip touches and activates said input sensor; and
(c) an imaging means, wherein said imaging means images a part of said user's hand large enough to identify said selected fingertip that activates said input sensor.

39. A system for selecting by a user a function from
$${\sum }_{i = 1}^{n} {m}_{i}$$
functions wherein said selection of said function is dependent on the identification of said user's fingertip and a motion made by said user's fingertip, comprising:
(a) an input sensor, wherein said input sensor is associated with said
$${\sum }_{i = 1}^{n} {m}_{i}$$
functions, and said
$${\sum }_{i = 1}^{n} {m}_{i}$$
functions correspond to n fingertips of said user and wherein said n fingertips respectively corresponds to m₁, . . . , mₙ motions; and
(b) said user to select said function by selecting at a given time only one of said n fingertips and only one of said corresponding motions for said selected fingertip, and only said selected fingertip motion touches and activates said input sensor.

40. The system as set forth in claim 39, further comprising an imaging means, wherein said imaging means images a part of said user's hand large enough to identify said selected fingertip that activates said input sensor.

41. The system as set forth in claim 39, further comprising a processing means to identify said selected motion.
